(19) United States
(12) Patent Application Publication
(10) Pub. No.: US 2024/0401887 A1
(43) Pub. Date: Dec. 5, 2024

(54) TEXTILE

(71) Applicant: ODM GMBH, Wattenheim (DE)

(72) Inventors: Werner KORDEL, Wattenheim (DE); Christopher KÜHN, Wattenheim (DE)

(21) Appl. No.: 18/698,508

(22) PCT Filed: Sep. 28, 2022
(86) PCT No.: PCT/EP2022/077061

§ 371 Date: Apr. 4, 2024

(30) Foreign Application Priority Data
Oct. 4, 2021 (DE) 102021125697.6
Oct. 4, 2021 (DE) 102021125701.8

(51) Int. Cl. F28D 20/02; B32B 5/02; B32B 5/26

(52) U.S. Cl. CPC F28D 20/023; B32B 5/02; B32B 5/26; B32B 2250/03; B32B 2250/20; B32B 2307/302; B32B 2437/00

(57) ABSTRACT

A textile formed from at least three layers, a carrier layer with an inner side T, an intermediate layer and a cover layer with an inner side D, wherein the intermediate layer is arranged between the carrier layer and the cover layer and is connected to the inner side T of the carrier layer and to the inner side D of the cover layer, wherein the cover layer has a cooling medium which is integrated in the cover layer.

### FIELD OF THE INVENTION

The invention relates to a textile formed from at least three layers, a carrier layer with an inner side T, an intermediate layer and the cover layer with an inner side D, wherein the intermediate layer is arranged between the carrier layer and the cover layer and the intermediate layer is connected to the inner side T of the carrier layer and to the inner side D of the cover layer.

### BACKGROUND OF THE INVENTION

A textile is already known that has a cooling medium so that the temperature is equalised with the skin.

US 2002/0132091 A1 describes a textile consisting of a fibre layer with a coating of PCM material on the top and underside.

WO 2010/044657 A2 describes a laminate material for the manufacture of foot-wear, consisting of a sublaminate which has a stretchable carrier layer and a further stretchable layer, wherein a further layer is provided which contains PCM material.

DE 20 2011 001 473 U1 describes a flexible flat structure with PCM material. A heat exchanger medium is also provided, which is in heat conducting contact with the PCM material.

### SUMMARY OF THE INVENTION

The invention is based on the task of forming and arranging a textile in such a way that an improved temperature equalisation or an improved cooling effect is achieved.

The problem is solved in accordance with the invention in that the cover layer is formed from a base material and a functional material, the cover layer having a cooling medium which is integrated in the cover layer. This ensures that the effect of the cooling medium, i.e. the temperature equalisation with the skin or the cooling effect, is improved. The additional intermediate layer ensures improved basic cooling, to which the cooling effect of the cooling medium is added. The base material and the functional material can be produced independently of each other. This means that the mass ratios of base material to functional material can be freely selected.

The cooling medium is a so-called PCM (phase change material) that can absorb body heat or heat from the skin, whereby it at least partially changes its aggregate state from solid to liquid. When the body or skin temperature drops again, the cooling medium releases heat again and thus undergoes a phase change back to the solid state. This ensures a constant temperature equalisation between the inner layer of material and the body or skin.

The PCM used here becomes liquid from a temperature of approx. 28° C. To do this, the PCM absorbs body heat and stores it up to a maximum temperature of 33° C. If the ambient temperature drops, the PCM becomes solid again and releases the stored heat through this process.

It can be assumed that the average mean temperature in the system is reduced by 2° C. in a linear fashion. However, this also means that the temperature peaks are bro-ken upwards and downwards. This significantly reduces the formation of sweat.

This temperature equalisation is kept going by air exchange or air movement. This air movement is only made possible in such a closed system by the intermediate layer. Air is trapped in the intermediate layer and is displaced by movement. This air movement causes higher temperature air to be moved to lower temperature points in the system or in the intermediate layer. The intermediate layer can be interwoven with the carrier layer and the cover layer for this purpose. Both the carrier layer and the cover layer can be designed as a fabric.

Interweaving eliminates the need for a barrier such as an adhesive layer in a laminate or in bonded fabrics. This allows the temperature-controlled air to come into direct contact with the temperature-equalising cover layer, which greatly increases the efficiency of heat exchange. This makes the structure rather soft and fluffy and adapts to the support surface or support shape.

The problem is also solved by using a textile as described above for the manufacture of protective clothing, protective waistcoats, protective trousers, bandages, shoes, headbands, caps, neck and neck scarves, headgear, bandages and gloves. Protective clothing can also relate in particular to thermal protection. Accordingly, leisure clothing can also be considered.

For this purpose, it can be advantageous if the base material is designed as a yarn or as a fibre or knitted fabric and/or if the functional material is designed as a yarn or as a fibre or knitted fabric and has the cooling medium as a further component that is embedded in the yarn or fibre. Both yarn and knitted fabric ensure good gas exchange. If the base material is also in the form of yarn or knitted fabric, the gas exchange is improved even further.

It can also be advantageous if the intermediate layer is designed as a spacer fabric and forms a pile filament structure consisting of several filaments arranged at a distance “a” with a longitudinal axis L, which are aligned with respect to the longitudinal axis L in a direction Q transverse to the inner side T and transverse to the inner side D. The pile filament structure is designed as a hair structure or rod structure, which keeps the carrier layer and the cover layer at a distance. This improves the heat exchange within the intermediate layer and thus the cooling effect of the cover layer.

Due to this construction, the textile is elastic vertically, or normal to the surface, and trapped air can therefore be moved or pumped. This means that the user's body movements partially compress the intermediate layer and move the trapped air to the side.

It can also be advantageous if the filaments of the intermediate layer form an angle with the inner side T and/or with the inner side D, with 80°<=β<=100°. An angle close to 90° increases the rigidity of the intermediate layer, as the filaments are primarily subjected to pressure along the longitudinal axis L by the cover layer and the carrier layer.

For this purpose, it can be advantageous if the filaments of the intermediate layer are arranged parallel to each other or enclose an angle α to each other, with α<=30°. The smallest possible acute angle increases the rigidity of the interlayer, as the filaments are orientated in different directions in relation to the longitudinal axis L, so that not only forces normal to the surface of the cover or carrier layer are well absorbed, but also forces that act on the cover or carrier layer at the above-mentioned angle β.

It can be of particular importance for the present invention if the interlayer has a maximum basis weight of 200 g/sqm (grams per square metre). This means that the fabrics or garments or protective clothing or protective equipment produced with it can have an advantageous weight.

In connection with the design and arrangement according to the invention, it can be advantageous if the cover layer is composed of a base material and a functional material which comprises the cooling medium, wherein the proportion of the functional material in the cover layer is 20% to 60% or 30% or 40% or 50%. The base material can be in the form of yarn or fibre. The functional material can also be in the form of yarn or fibre.

A higher proportion of functional material increases the mass of cooling medium or paraffin. However, this does not fundamentally improve the temperature equalisation, but extends the duration of temperature absorption and temperature release. In addition, a higher proportion of functional material than 30% can lead to problems in the production of the functional material, such as a yarn.

It can be advantageous here if the functional material has a specific heat absorption of at least 50 J/g (joules per gram). In practice, 50 J/g is a sufficient value to sustainably improve the wearing comfort of the textile produced with it. With a proportion of 30% functional material, a specific heat absorption of around 16 J/g can theoretically be expected. This value can be influenced by the processing, in particular the colouring and finishing of the cover layer.

It can also be advantageous if the cover layer has a maximum surface weight of 230 g/sqm to 290 g/sqm or 250 g/sqm or 270 g/sqm. This achieves at least a relative maximum of specific heat absorption. Increasing the proportion of functional material beyond 40% or 30% does not lead to a significant increase in specific heat absorption. Only the weight per unit area of the intermediate layer increases due to the higher specific density of the functional material. An optimum surface density is therefore achieved using the above-mentioned proportion of functional material in relation to the specific heat absorption of the cover layer. An optimum ratio between the specific heat absorption and the weight per unit area of the intermediate layer is achieved.

It can also be advantageous if a maximum basis weight of 500 g/sqm to 600 g/sqm or 485 g/sqm or 550 g/sqm is provided. This makes the textile relatively light.

### BRIEF DESCRIPTION OF THE DRAWINGS

Further advantages and details of the invention are explained in the patent claims and in the description and shown in the figures. It shows:

FIG. 1 a schematic sketch of the structure of the textile;

FIG. 2 a schematic sketch of a relative embodiment;

FIG. 3a a schematic sketch of the textile;

FIG. 3b a schematic sketch of the functional material.

### DETAILED DESCRIPTION OF THE INVENTION

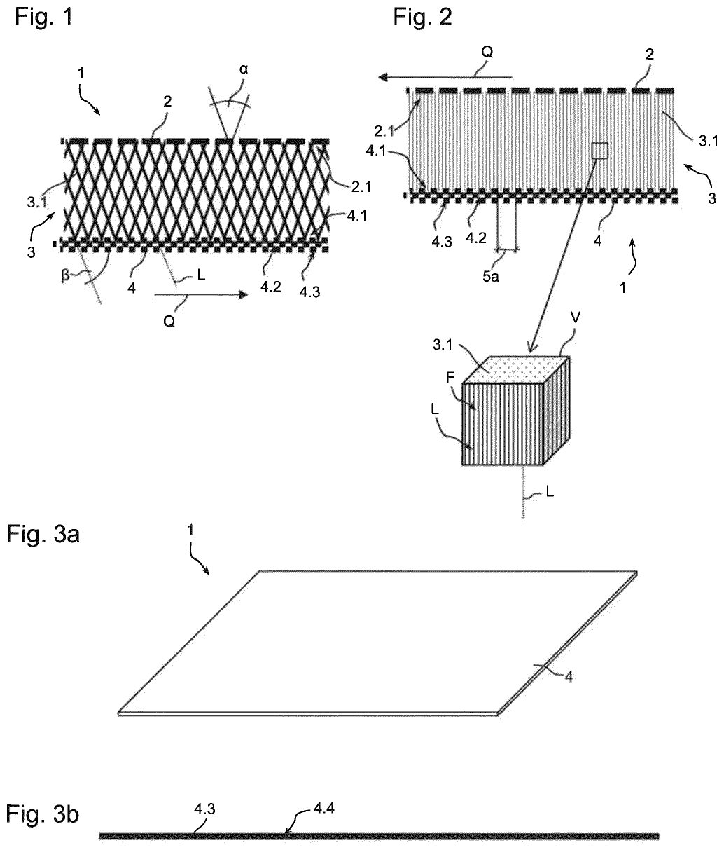

According to FIGS. 1, 2, the textile 1 has the aforementioned cover layer 4 and the carrier layer 2, as well as an intermediate layer 3 arranged between the cover layer 4 and the carrier layer 2. While the cover layer 4 and the carrier layer 2 are formed from a textile material, the intermediate layer 3 has a filament or hair structure. According to the embodiment example in FIG. 1, the filaments 3.1 or hairs are arranged at an angle α to each other. This angle α is an acute angle of approximately 40°. According to embodiment example FIG. 2, the filaments 3.1 or hairs 3.1 are aligned parallel to each other and at the same time normal to the adjacent cover layer 4 or carrier layer 2. They are spaced at a distance “a”, with five times the distance 5a shown in FIG. 2. The intermediate layer 3 is mechanically connected to both the cover layer 4 and the carrier layer 2, for example by weaving.

As shown in principle in FIG. 2, the intermediate layer 3 has a volume V, which is made up of the volume F of the filaments 3.1 contained therein and the remaining air volume U. The ratio F/U of filaments to air is between 0.01 and 0.1.

As shown in FIGS. 1 and 2, the cover layer 4 has a cooling medium 4.4, which is integrated into the cover layer 4 in the form of paraffin. The cover layer 4 is formed from a base material 4.2 and a functional material 4.3, both of which can be present as fibres or both of which can be processed into a common fibre. The cover layer 4 is woven from the two fibres or from the common fibre.

According to FIG. 3a, the three-layer textile has a flat structure. The functional material 4.3 in FIG. 3b is designed as a yarn or fibre and has the cooling medium 4.4.

### LIST OF REFERENCE SYMBOLS

1 Textile, climate fabric
2 Carrier layer
2.1 Inner side T
3 Intermediate layer
3.1 Filament
4 Cover layer
4.1 Inner side D
4.2 Base material
4.3 Functional material
4.4 Cooling medium
a Distance
F Volume of the filaments
U Volume of enclosed air
V Volume
α Angle
β Angle

### OTHER NOMENCLATURE

Longitudinal axis L of filament 3.1
Direction Q from longitudinal axis L

What is claimed is:

1. A textile formed from at least three layers, a carrier layer with an inner side T, an intermediate layer and a cover layer with an inner side D, wherein the intermediate layer is arranged between the carrier layer and the cover layer and is connected to the inner side T of the carrier layer and is connected to the inner side D of the cover layer,
wherein the cover layer is formed from a base material and a functional material, wherein the functional material is formed as a yarn or as a fibre which has a cooling medium as a further component embedded which is integrated in the cover layer.

2. The textile according to claim 1, wherein the base material is formed as a yarn or as a fibre and wherein the functional material is formed as a yarn or as a fibre and has the cooling medium as a further component which is embedded in the yarn or the fibre.

3. The textile according to claim 1, wherein the intermediate layer is designed as a spacer fabric and forms a pile filament structure consisting of a plurality of filaments arranged at a distance “a” with a longitudinal axis L, which are aligned with respect to the longitudinal axis L in a direction Q transverse to the inner side T and transverse to the inner side D.

4. The textile according to claim 1, wherein the filaments of the intermediate layer form an angle β with the inner side T and/or with the inner side D, with 80°<=β<=100°.

5. The textile according to claim 1, wherein the filaments of the intermediate layer are arranged parallel to each other or form an angle α to each other, with α<=30°.

6. The textile according to claim 1, wherein the intermediate layer has a basis weight of at most 200 g/m².

7. The textile according to claim 1, wherein the proportion of the functional material in the cover layer is 20% to 60% or 30% or 40% or 50%.

8. The textile according to claim 1, wherein the functional material has a specific heat absorption of at least 50 J/g.

9. The textile according to claim 1, wherein the cover layer has a basis weight of at most 230 g/sqm to 290 g/sqm or 250 g/sqm or 270 g/sqm.

10. The textile according to claim 1, wherein a basis weight of at most 400 g/sqm to 600 g/sqm or 485 g/sqm or 550 g/sqm is provided.

11. A use of a textile according to claim 1 for the manufacture of protective clothing, protective waistcoats, protective trousers, bandages, shoes, headbands, caps, neck and neck scarves, headgear, bandages and gloves.

12. The textile according to claim 2, wherein the intermediate layer is designed as a spacer fabric and forms a pile filament structure consisting of a plurality of filaments arranged at a distance “a” with a longitudinal axis L, which are aligned with respect to the longitudinal axis L in a direction Q transverse to the inner side T and transverse to the inner side D, and wherein the filaments of the intermediate layer form an angle β with the inner side T and/or with the inner side D, with 80°<=β<=100°.

13. The textile according to claim 12, wherein the filaments of the intermediate layer are arranged parallel to each other or form an angle α to each other, with α<=30°, and wherein the intermediate layer has a basis weight of at most 200 g/m².

14. The textile according to claim 13, wherein the proportion of the functional material in the cover layer is 20% to 60% or 30% or 40% or 50%, and wherein the functional material has a specific heat absorption of at least 50 J/g.

15. The textile according to claim 14, wherein the cover layer has a basis weight of at most 230 g/sqm to 290 g/sqm or 250 g/sqm or 270 g/sqm, and wherein a basis weight of at most 400 g/sqm to 600 g/sqm or 485 g/sqm or 550 g/sqm is provided.

16. A use of a textile according to claim 15 for the manufacture of protective clothing, protective waistcoats, protective trousers, bandages, shoes, headbands, caps, neck and neck scarves, headgear, bandages and gloves.
